(19) United States
(12) Patent Application Publication
(10) Pub. No.: US 2008/0208948 A1
(43) Pub. Date: Aug. 28, 2008

(54) METHODS AND APPARATUS FOR USING BOOLEAN DERIVATIVES TO PROCESS DATA

(76) Inventors: Karen A. Panetta, Rockport, MA (US); Sos Agaian, San Antonio, TX (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/038,152

(22) Filed: Feb. 27, 2008

Related U.S. Application Data
(60) Provisional application No. 60/891,817, filed on Feb. 27, 2007.

(51) Int. Cl. G06F 17/14

(52) U.S. Cl. 708/820

(57) ABSTRACT

Method and apparatus for generating an Nth order Boolean derivative from r bit-array Qth order partial derivatives combined using fusion. Exemplary applications include multimedia, e.g., signal, image and video, processing systems; security systems; edge detection, compression, filtering, multimedia data, e.g., signal, image, video, interpolation and resizing systems; biometrics and recognition systems; networking and communication systems; static hazard free circuit design, simplifying gates in circuits; circuit testing, fault detection, and analysis systems.

### CROSS REFERENCE TO RELATED APPLICATIONS

The present application claims the benefit of U.S. Provisional Patent Application No. 60/891,817, filed on Feb. 27, 2007, which is incorporated herein by reference.

### BACKGROUND

As is known in the art, partial derivatives can be used in an attempt to extract various information. For example, U.S. Pat. No. 5,291,612 to Sosic et al. discloses techniques for evaluating Boolean expressions using a total differential that generates tree-structured processing elements. While it is known to use partial derivatives the prior art does not contain a technique for efficiently calculating r bit-array partial derivatives or derivatives for Boolean Functions and Boolean Networks of the Nth order. This is due to the fact that a Boolean derivative can contain only a zero or a one, and a Boolean function can contain many variables. Classical calculus only defines a partial derivative for a single variable of a function.

### SUMMARY

The present invention provides methods and apparatus to generate Boolean derivatives using, so called, r bit-array partial derivatives (If parameter r=1, the one bit-array partial derivatives become a commonly used Boolean partial derivatives with respect to the given variable) of a Boolean function with respect to the given array of variables. With this arrangement, several data processing implementations for various applications can be efficient and fast. While the invention is primarily shown and described using certain exemplary embodiments and applications, such as edge detection and image compression, it is understood that the invention is relevant to applications in general in which it is desirable to process data, such as image/video processing (for instance image/video interpolation, resizing and de-noising, compression and representation, object/target localization, classifications, and recognitions), signal processing, multimedia processing, system biology, cellular automata logic circuit design, software design, encryption, multimedia security (data hiding, steganography, watermarking), hardware design, recognition, fault detection, compression, filtering, de-noising, and minimizing hardware designs.

In one aspect of the invention, a method comprises a method comprises transforming a data stream into a Boolean function, minimizing the Boolean function, performing r bit-array Q-th order partial derivatives of the Boolean function, where Q=1 . . . N, combining the r bit-array partial derivatives to generate an N-th order Boolean derivative using fusion, and outputting the Boolean derivative.

The method can further include one or more of the following features: outputting the Boolean derivative to a data processing application, such as multimedia (image, video, data) processing systems, security, biometric, system biology, static hazard free circuit design, simplifying gates in circuits, circuit testing, fault detection and analysis, networking and communication system. The fusion includes a technique selected based upon applications and may be simplified by using a Boolean function minimizing technique. For example, the fusion may use one or more of averaging, minimum, maximum, minimum/maximum, maximum/minimum operations; exclusive-ORing a sum of primary implicants, and performing implicant expansion of the primary implicants.

In another aspect of the invention, an article comprises a storage medium having stored thereon instructions that when executed by a machine result in transforming a data stream into a Boolean function, minimizing the Boolean function, performing r bit-array Q-th order partial derivatives of the Boolean function, where Q=1 . . . N, combining the r bit-array partial derivatives to generate an Nth order Boolean derivative using fusion, and outputting the Boolean derivative.

In a further aspect of the invention, a system comprises a processor, a memory coupled to the processor, the memory including instructions that when executed enable: transforming a data stream into a Boolean function, minimizing the Boolean function, performing r bit-array Q-th order partial derivatives of the Boolean function, where Q=1 . . . N, combining the partial derivatives to generate an Nth order Boolean derivative using fusion, and outputting the Boolean derivative.

### BRIEF DESCRIPTION OF THE DRAWINGS

The exemplary embodiments contained herein will be more fully understood from the following detailed description taken in conjunction with the accompanying drawings, in which:

FIG. 1 is a block diagram of a system to generate Boolean derivatives for use by a data processing application in accordance with exemplary embodiments of the invention;

FIG. 2 is a block diagram showing exemplary processing functions in accordance with exemplary embodiments of the invention;

FIG. 2A is a block diagram showing further details of exemplary minimization processing in FIG. 2;

FIG. 3 is a diagram of exemplary processing to provide calculation of Nth order Boolean derivatives in accordance with exemplary embodiments of the invention;

FIG. 4 is a block diagram showing further details of Nth order Boolean derivative generation in accordance with exemplary embodiments of the invention;

FIGS. 5A-E show exemplary processing for a 4×4 (p=q=4) pixel image having a vertical edge;

FIGS. 6A-E show exemplary processing for a 4×4(p=q=4) pixel image having a diagonal edge;

FIGS. 7A-E show exemplary processing for a 4×4 (p=q=4) pixel image having a random block;

FIG. 8 is a block diagram showing additional details of Boolean derivative generation in accordance with exemplary embodiments of the invention;

FIGS. 9A-G show processing of an image using Boolean Derivatives in accordance with exemplary embodiments of the invention; and

FIG. 10 shows an exemplary process for generating an output binary image for an input grayscale image.

### DETAILED DESCRIPTION

The present invention provides methods and apparatus for calculating Boolean derivatives for processing applications. While the invention is shown and described in conjunction with certain exemplary implementations, processing steps, and applications, other embodiments of the present invention are applicable to a wide range of applications including recognition, fault detection, compression (lossless and lossy), edge detection, for genome-wide expression data processing and modeling, multimedia processing, system biology, encryption, multimedia security (data hiding, watermarking), filtering, de-noising and minimizing hardware designs, logic circuit testing, and the like.

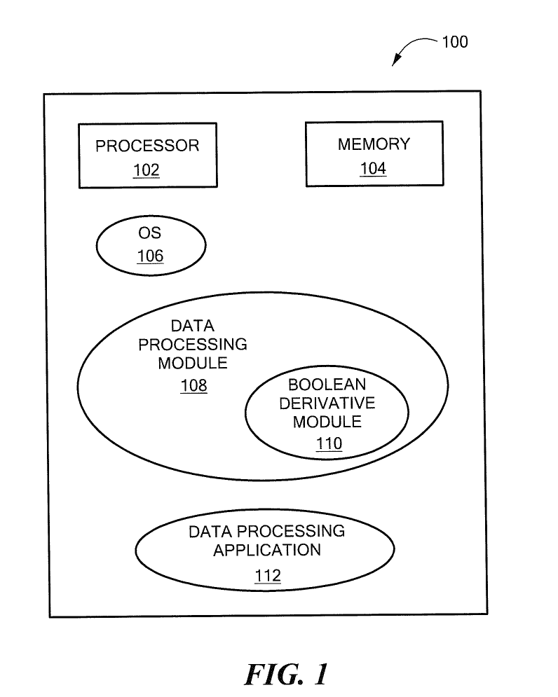

FIG. 1 shows an exemplary system 100 for generating Boolean derivatives in accordance with exemplary embodiments of the present invention. A processor 102 and memory 104 are supported by an operating system 106 in a manner well known to one of ordinary skill in the art. A data processing module 108 includes a Boolean derivative module 110 to generate Nth order Boolean derivatives, as described in detail below. The Boolean derivatives can be output to a local or remote data processing application 112, such as an edge detection application.

In general, embodiments of the present invention define and apply Nth order Boolean Derivatives of any Boolean function by using r bit-array Qth order partial derivatives of the same Boolean function and a dynamic fusion method to combine the partial derivatives to yield the Nth order Boolean Derivative. It is understood that the invention is not a function of multiple order partial derivatives. For instance, the first order derivative is computed using only the first order partial derivatives. If the Nth order total Boolean derivative of a function is required, then only the Qth order r bit-array partial is computed and all the lesser order partial derivatives do not need to be stored. With this arrangement, significantly less computation time and memory are required. It is understood that as used herein a Boolean derivative is generated from a process to combine/integrate information from multiple Boolean partial derivatives into one. The particular fusion method can be adapted and tuned for a variety of applications, such as edge detection in images, recognition, filtering, de-noising, compression or performing fault diagnosis in digital circuit hardware.

For edge detection, the fusion can be provided in generally two ways in which different partial derivatives are combined. One approach is to create a derivative, by calculating the partial derivatives. The results are subsequently combined (using, for example, a binary or nonlinear operators, such as AND or OR). Examples of this include linear combinations of the data, fusion using the max or min operator, or other non-linear combinations. Another example includes combining the partial derivatives histogram based thresholding methods. Further, local spread of intensity values in the image (average of partial derivatives) can be measured. The image is thresholded using some threshold, based on the noise level in the image and binaryzing to the ending edge map. The thresholding can be chosen arbitrarily, and different selections produce different output depending on the structure of the input data.

In an exemplary embodiment, an inventive new measure is provided for automatically performing the thresholding step. Given an input image of size m-by-n, the output fusion image

Fision_Binary zed_Image={Fᵢⱼ}

Where Fᵢⱼ is determined via a evaluation between the entire image “average” (arithmetic. geometric, statistical and others) with a q-by-p (where q and p are arbitrary integer numbers) running block Bᵢⱼ “average” (arithmetic, geometric, statistical and others). This process is defined:

$${F}_{ij} = \{ \begin{matrix}1 & if \frac{a function of the block {B}_{ij} “ average ”}{a function of the entire image “ average ”} \geq β \\ 0 & else\end{matrix}$$

Where Fᵢⱼ is the element of the fused pixel located at image pixel (ij). The scaling factor from 0≦β≦1 can be set depending on the class of input signals used.

Another partial derivative fusion (combination) approach is to separate the class of the partial derivatives say into two classes, and take the “average” of these classes, then threshold them simultaneously by choosing the thresholds so that the mutual information between the two thresholded signals is maximized. They can be also fused by jointly using trigonometric systems and wavelet packets.

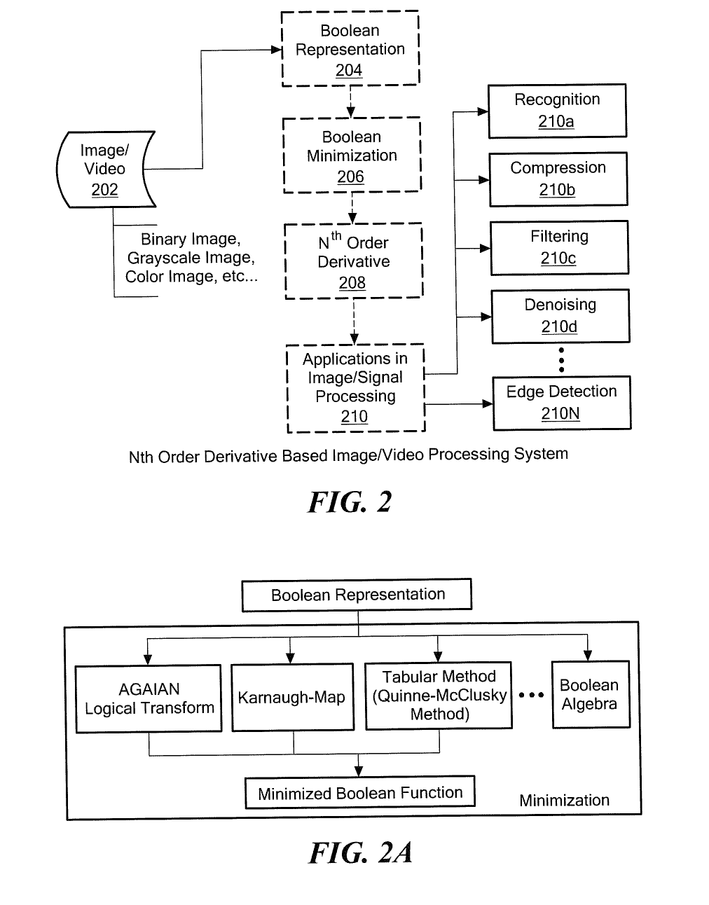

FIG. 2 is a high-level block diagram of an exemplary data processing system 200 in accordance with exemplary embodiments of the invention. In one embodiment, input image/video data 202, which can include binary, grayscale, color image etc., is provided to a Boolean representation module 204 for transformation of the input data 202 into a Boolean function. A Boolean minimization module 206 minimizes the transformed data from the Boolean representation module 204.

As shown in FIG. 2A, the Boolean minimization module 206 can use a variety of known techniques, such as K-maps, Quinne-McCluskey methods, Reed-Muller (Zhegalkin) polynomial (Akers, S. B., On a Theory of Boolean Functions, SIAM J., 1959, vol. 7, no. 4, pp. 487-498) or the Agaian et al. method referred to as the Logical/Binary) Transform. It is understood that by minimizing the Boolean function, the resulting function can be more efficiently implemented in software or hardware. Exemplary Agaian logical transforms are disclosed in S. Agaian, J. Astola, and K. Egiazarian, “Binary Polynomial Transforms and Nonlinear Digital Filters,” Marcel Dekker, Inc. 1995, and S. Agaian, T. Baran, and K. Panetta, “Filtering of Impulse Noise in Digital Signals Using Logical Transforms,” Proceedings of SPIE Mathematical Methods in Pattern and Image Analysis,” vol. 5916, 2005, which are incorporated herein by reference. Logical transforms are used to represent data with equations that can be minimized down to equivalent representations.

Again referring to FIG. 2, an Nth order derivative module 208 performs arbitrary Qth order partial derivatives of the Boolean function, where Q=1 . . . N. The partial derivatives are then combined to generate the Boolean Derivative of the function using fusion and thresholding operation, as described more fully below. A fusion method can be chosen specifically for the target application. Exemplary fusion methods include averaging, minimum, maximum, Minimum/Maximum, Maximum/Minimum and are also discussed above.

The data from the Boolean derivative module 208 can be used in an image/signal processing application 210, for example. Exemplary applications include recognition 210a, compression 210b, filtering 210c, de-noising 210d, and edge detection 210N.

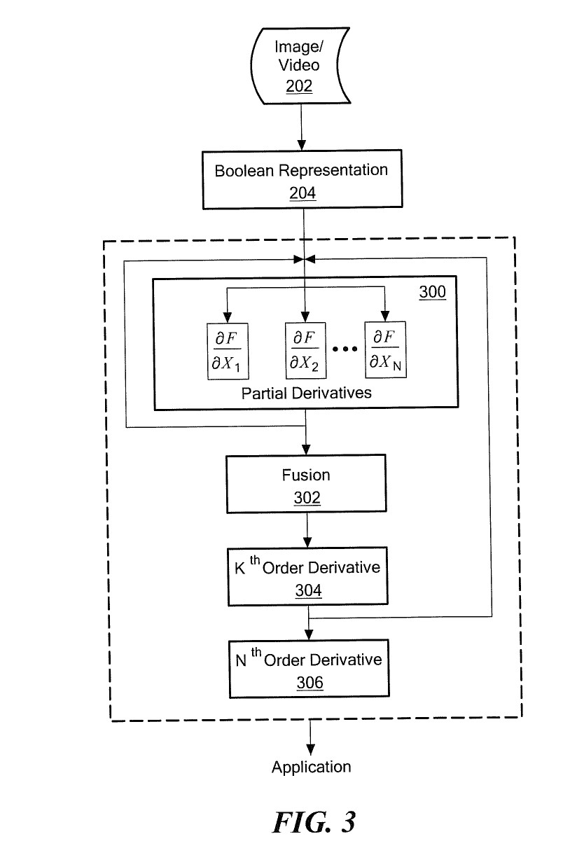

FIG. 3 shows further details of iterations to compute any order N for a Boolean derivative. Any desired iteration can be chosen to take the Nth order derivative of a function. A partial derivative module 300 computes partial derivatives in an iterative manner, as described more fully below. A fusion module 302 fuses the partial derivative information to generate a Nth order derivative 304. Further partial derivative processing occurs until the Nth order derivative processing 306 is reached. In general, the fusion is different for each iteration.

With this arrangement, inventive embodiments provide Boolean Derivative calculations in efficient implementations. Depending on the choice of the fusion method, fast efficient hardware or software for any imaging or logic circuit design application can be provided. This allows imaging systems to run faster and provides low-cost implementation choices such that imaging hardware can be used in applications that are currently prohibitive in cost. For example, the invention could be used to develop low-cost cameras for applications, where the cameras will not be retrieved. Consider a battlefield application where many cameras are scattered across an area to provide a survey of the field. The mobile cameras should be cheap enough to eliminate the need for retrieval and yet efficient enough to provide accurate crucial information quickly. Using classical computational methods for detection is not cost-effective and prevents applications like this from becoming practical. In contrast with prior art systems that require storage of huge amounts of image data, exemplary camera system embodiments require far less storage since only Q-th level partial derivative data is used. In addition, since processing is based upon logical operations, e.g., AND and OR operations, significantly less processing resources are required.

In another embodiment, files can be compressed for transmission. For example, embodiments of the invention can be used instead of the JPEG standard. Embodiments of the invention compress data into relatively small size while allowing high quality image reconstruction. In another embodiment, image transmission from a space vehicle, such as the Space Shuttle enables efficient image transmission without artifacts in the reconstructed image.

It is understood that various partitions between hardware and software to meet the needs of a particular application will be readily apparent to one of ordinary skill in the art.

The invention is described below in detail in conjunction with edge detection within two-dimensional signals (images). Using Boolean partial derivatives calculated through a logical transform, the algorithm generates a binary edge map. The process is initially described for binary data and then extended for multi-bit (grayscale) images.

As is well known in the art, edge detection refers to the process of determining edge pixels within an image. Edge detection is often used in feature-based multimedia (image, video) processing and within scene analysis systems. For example, military applications involving machine vision tasks, such as object recognition and motion analysis, often rely on the accurate identification of edges. Further, security applications including data coding, data hiding, and watermarking also benefit from improved edge detection capabilities.

Within an image, edges may contain information regarding the objects contained within a scene. Shading often defines the three-dimensional shape in an image, but accurate edge detection separates objects from the background assisting with the identification of the edge boundaries, and allowing the possibility of further calculations, such as area, perimeters, and shape of scene elements.

Most known techniques currently used for edge detection are based on identifying abrupt changes in the pixel values, often through analysis of the first or second derivative of the image data. The Canny edge detection technique, whose Canny Filter is one of the most widely known edge detecting procedures, attempts to develop an edge-detecting filter with good detection and good localization while retaining a low spurious response. Maintaining those low levels of addition noise becomes difficult when using real world images, which often have added noise due to factors such as varying light intensities, atmospheric effects, and camera/lens specifications, especially since the first or second derivatives, both of which have high-pass characteristics, often result in an emphasizing of the noise within an image.

An exemplary embodiment of the invention includes employing partial derivatives of Boolean functions representation for block data, calculated using the Agaian et al logical transform, for example. The procedure generates a binary edge map indicating the location of edge data within the original image. While initially for binary data, it is understood the process can be readily extended to grayscale in an iterative fashion on thresholded versions of the multi-bit data. The threshold parameters allow the algorithm to be adjusted dynamically, providing the customization of the level of detail returned, often depending on the input quality of the original image.

As discussed above, partial derivatives, in the general sense, are the derivatives of an individual variable from a multi-variable function while the others are held constant. These can be useful in determining how a function changes with respect to that variable. In edge detection, edges can be detected as locations where there is rapid change, often identified by the first or second derivatives. In an exemplary embodiment, edge detection uses a first order Boolean derivative.

With binary data, however, it is not possible to take a partial derivative using conventional techniques. However, it is possible the take the partial derivatives of Boolean functions. These equations allow the original data to be transformed and divided into a series of individual functions, one for each Boolean input variable of the original data. To assist with this transformation, Agaian et al developed a fast algorithm for quickly calculating these partial derivatives for binary data, as set forth briefly below.

Definition 1: A Boolean function with n variables is a function from the set of n-bit vectors. A Boolean (switching) function F is a mapping F: Bⁿ→B, where B={0, 1}.

Definition 2: In the truth table of a switching function of N variables, there are 2̂N rows. Each of these rows represent an input state vector called a minterm. (see, e.g., R. K. Brayton, G. D. Hachtel, C. T. McMullen, and A. L. Sangiovanni-Vincentelli, Logic Minimization Algorithms for VLSI Synthesis, Kluwer Academic Publishers, Boston, 1984).

Let f(x) be a Boolean n-variable function where f(x)=f(x₁, x₂, . . . , xₙ) denoted by

ƒ(x^{(j,0)})=ƒ(x₁, . . . , pⱼ₋₁, . . . , pⱼ, . . . , pⱼ₊₁, . . . xₙ)

where pⱼ₋₁, . . . , pⱼ, . . . , pⱼ₊₁=0,1

Definition 3. The r bit-array partial derivative of the Boolean function with respect to the variable xⱼ can be represented as:

$$\frac{\partial f ( x )}{\partial {x}_{j}} = f ( {x}^{( j , 0 )} ) ⊕ f ( {x}^{( j , 1 )} )$$

where ⊕ is addition modulo 2 (exclusive OR) and where r is a parameter such as 1, 2, 3, . . . n.

The partial derivative specifies whether a change in the jth input causes a change in the original function x. If parameter r=1, the one bit-array partial derivative of the Boolean function become a commonly used first order Boolean partial derivative with respect to the variable xⱼ that can be represented as:

$$\frac{\partial f ( x )}{\partial {x}_{j}} = f ( {x}^{( j , 0 )} ) ⊕ f ( {x}^{( j , 1 )} )$$

where ⊕ is addition modulo 2 (exclusive OR) and where

m=0 ƒ(x^{(j,0)})=ƒ(x₁, . . . , xⱼ₋₁,0,xⱼ₊₁, . . . xₙ)

m=1 ƒ(x^{(j,1)})=ƒ(x₁, . . . , xⱼ₋₁,1,xⱼ₊₁, . . . xₙ

The partial derivative is a Boolean function itself that specifies whether a change in the jth input causes a change in the original function x.

Example: Consider the one-dimensional input vector

ƒ(x)=ƒ(x₁,x₂,x₃)=(0,0,0,0,0,1,1,1)=x₁x₂νx₁x₃

a Boolean function of three variables (n=3). Using equations 1, 2, and 3 above, the three commonly used partial derivatives can be calculated. Next to each is also the sum of primary implicants (S) representation of the output data.

$$\begin{matrix}\frac{\partial f ( x )}{\partial {x}_{1}} = \frac{\partial f ( {x}_{1} , {x}_{2} , {x}_{3} )}{\partial {x}_{1}} \\ = f ( {x}^{( 1 , 0 )} ) ⊗ f ( {x}^{( 1 , 1 )} ) \\ = ( 0 \text{,} 1 \text{,} 1 \text{,} 1 \text{,} 0 \text{,} 1 \text{,} 1 \text{,} 1 )\end{matrix} \\ S \text{:} {x}_{2} + {x}_{3} \\ \begin{matrix}\frac{\partial f ( x )}{\partial {x}_{2}} = \frac{\partial f ( {x}_{1} , {x}_{2} , {x}_{3} )}{\partial {x}_{2}} \\ = f ( {x}^{( 2 , 0 )} ) ⊕ f ( {x}^{( 2 , 1 )} ) \\ = ( 0 \text{,} 0 \text{,} 0 \text{,} 0 \text{,} 1 \text{,} 0 \text{,} 1 \text{,} 0 )\end{matrix} \\ S \text{:} {x}_{1} {x}_{3} \\ \begin{matrix}\frac{\partial f ( x )}{\partial {x}_{3}} = \frac{\partial f ( {x}_{1} , {x}_{2} , {x}_{3} )}{\partial {x}_{3}} \\ = f ( {x}^{( 3 , 0 )} ) ⊕ f ( {x}^{( 3 , 0 )} ) ⊕ f ( {x}^{( 3 , 1 )} ) \\ = ( 0 \text{,} 0 \text{,} 0 \text{,} 0 \text{,} 1 \text{,} 1 \text{,} 0 \text{,} 0 )\end{matrix} \\ S \text{:} {x}_{1} {\overline{x}}_{2} \qquad ( 4 )$$

As a fast implementation method for calculating the first order partial derivative of the Boolean function, referred to as the j^{th} partial derivative transform (equation 5) and can be used by using the following matrix multiplication presented by Agaian et al [in S. Agaian, J. Astola, and K. Egiazarian, “Binary Polynomial Transforms and Nonlinear Digital Filters,” Marcel Dekker, Inc. 1995]:

$$\frac{\partial f ( x )}{\partial {x}_{j}} = ( {Ξ}_{n}^{( j )} \cdot f ( x ) ) ( \text{mod} 2 ) \qquad ( 5 )$$

where the partial derivative matrix Ξₙ^{(j)} is defined as:

Ξₙ^{(j)}=Iⱼ₋₁\hat{x}(1,1)\hat{x}Iₙ₋ⱼ (6)

As an example, the three partial derivative matrices (for an input vector of size 8, when n=3) are shown in Equation 7 below. The matrices, for all values of n and j, only have two nonzero elements in each row (both of which equal one). Thus, the matrix multiplication from Equation 7 can be implemented in software or hardware as a sequence of additions. The total number of additions for deriving all partial derivatives for a given Boolean input function is n2ⁿ⁻¹.

$${Ξ}_{3}^{( 1 )} = [ \begin{matrix}1 & 0 & 0 & 0 & 1 & 0 & 0 & 0 \\ 0 & 1 & 0 & 0 & 0 & 1 & 0 & 0 \\ 0 & 0 & 1 & 0 & 0 & 0 & 1 & 0 \\ 0 & 0 & 0 & 1 & 0 & 0 & 0 & 1\end{matrix} ] \\ {Ξ}_{3}^{( 2 )} = [ \begin{matrix}1 & 0 & 1 & 0 & 0 & 0 & 0 & 0 \\ 0 & 1 & 0 & 1 & 0 & 0 & 0 & 0 \\ 0 & 0 & 0 & 0 & 1 & 0 & 1 & 0 \\ 0 & 0 & 0 & 0 & 0 & 1 & 0 & 1\end{matrix} ] \\ {Ξ}_{3}^{( 3 )} = [ \begin{matrix}1 & 1 & 0 & 0 & 0 & 0 & 0 & 0 \\ 0 & 0 & 1 & 1 & 0 & 0 & 0 & 0 \\ 0 & 0 & 0 & 0 & 1 & 1 & 0 & 0 \\ 0 & 0 & 0 & 0 & 0 & 0 & 1 & 1\end{matrix} ] \qquad ( 7 )$$

While Agaian et al's j^{th} partial derivative transform does decrease the overall complexity of the calculations required for calculating the partial derivative of the Boolean function, there can still be a further reduction though a minimization of the original function. As discussed above, the operations performed required the original binary data vector in its entirety. Rather than working with the raw data in this way, a logical transform is employed which transforms the data from the binary domain to the Boolean domain, creating a minimized representation called the summation of primary implicants. This novel representation can then be used for the quick calculation of the partial derivatives.

We can also extend the definition to higher order derivatives. For example, a second order partial derivative with respect to xi and xj is defined as

$$\frac{{\partial }^{2} f ( x )}{\partial {x}_{j} \partial {x}_{i}} = \frac{\partial }{\partial {x}_{j}} f ( {x}^{( i , 0 )} ) ⊗ \frac{\partial }{\partial {x}_{j}} f ( {x}^{( i , 1 )} )$$

Note that the definition is consistent with the usual chain rule for derivatives, i.e.,

$$\frac{{\partial }^{2} f ( x )}{\partial x \partial y} = \frac{\partial }{\partial y} ( \frac{\partial f}{\partial {x}_{j}} )$$

We can define a second order Boolean derivative as a process to combine/integrate information from multiple Boolean using above second order partial derivatives into one.

Exemplary logical/binary transform (it can be generated logical transform with minimizing the following property) is defined as follows for input vectors f of length N (N=2ⁿ or n=log₂ N, where n and N are both integer values):

y=δ₁{Bₙδ₀[Aₙ^{T}δ₀(f)]}

In the equation above, δₚ is the Kronecker Delta which accepts and returns a one-dimensional vector where p-valued elements are set to 1 and all others to 0. The matrices A and B are defined as follows:

$${A}_{n}^{T} = {[ \begin{matrix}1 & 0 \\ 0 & 1 \\ 1 & 1\end{matrix} ]}^{⊗ n} , {B}_{n} = {[ \begin{matrix}1 & 0 & 1 \\ 0 & 1 & 1 \\ 0 & 0 & 1\end{matrix} ]}^{⊗ n}$$

The output y is a one-dimensional binary input vector of length 3ⁿ (due to the A matrix's asymmetrical size). The sum of primary implicants is composed of one term for each 1-valued entry in the y vector. To determine the structure of individual terms, one considers the base-3 representation of the index (position) in the y vector (yₜ=1, where yₜ is the t^{th} element of y) in the following way:

tᵢ=0 x̅ᵢ
if tᵢ=1 then xᵢ is included in this term.

tᵢ=2 1

A value of “1” in the term (when t=2) indicates a “don't care” condition, and can be omitted from the written representation.

Deriving the original binary function from the “sum” of primary implicants representation (this is a one-to-one function) is achieved through an operation called primary implicant expansion, which is the inverse procedure of the logical transform. This is not a mathematical mirror image of the forward transform, but rather has a significantly lower overall complexity:

$${f}_{m} = {\sum }_{i = 0}^{{3}^{n} - 1} {y}_{t} {\prod }_{i = 0}^{n - 1} [ {δ}_{m} ( {y}_{{t}_{i}} ) + {δ}_{2} ( {y}_{{t}_{i}} ) ] for m = 0 to N - 1$$

where, mᵢ is the i^{th} digit of the base-2 representation of the index m.

In terms of computational requirements for calculating the logical transform, there exists a fast implementation that replaces the multiplication of matrices of A and B with a recursive series of additions: 2(3 ⁿ−2ⁿ) addition operations for the A matrix, and (2n 3ⁿ⁻¹) addition operations for the B matrix.

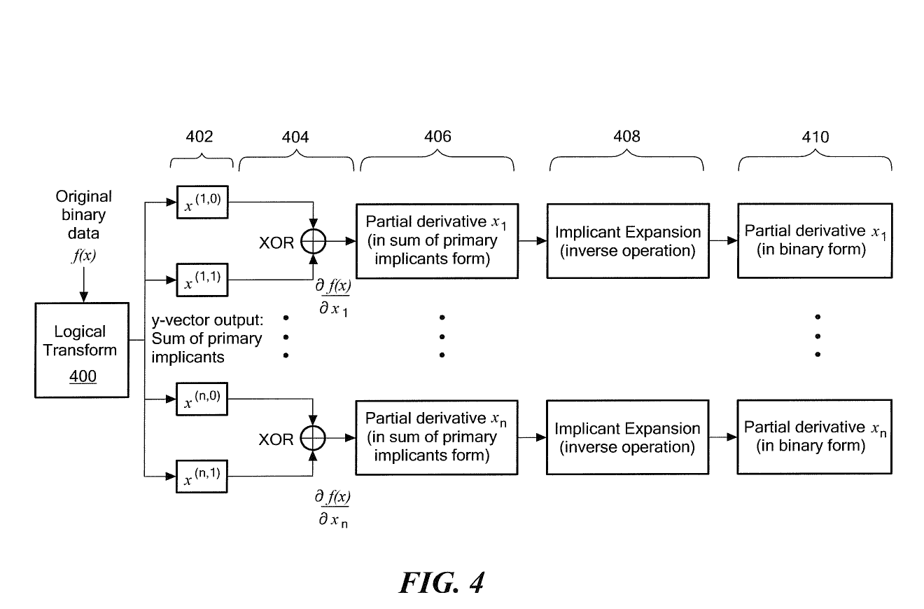

Using the logical transform to create the sum of primary implicants representation from the original binary data quickly, FIG. 4 illustrates how this transform is incorporated into the process for generating the partial derivatives of Boolean functions. The original binary data is fed into the logical transform 400. This calculation only occurs once, therefore keeping the algorithm efficient. The resulting sum of primary implicants 402 generated by the logical transform 400 is then duplicated and individual copies are passed to the next step. Creating the x^{(j,0)} and x^{(j,1)} vectors can be achieved via a single matrix multiplication (again reducible to a series of additions). An XOR operation 404 creates the partial derivative for each variable. Resulting from the XOR operation is the partial derivative in the sum of primary implicants representation 406. If the binary data is required, the algorithm continues with implicant expansion 408 in order to return it back to the original domain (binary form) 410.

It is understood that the A and B matrices for the Logical Transform referred to in Equations 8, which provides the basic formula, 9, and 10 can be readily manipulated to meet the needs of a particular application. That is, the A and B matrices can be modified to obtain different features depending upon the application.

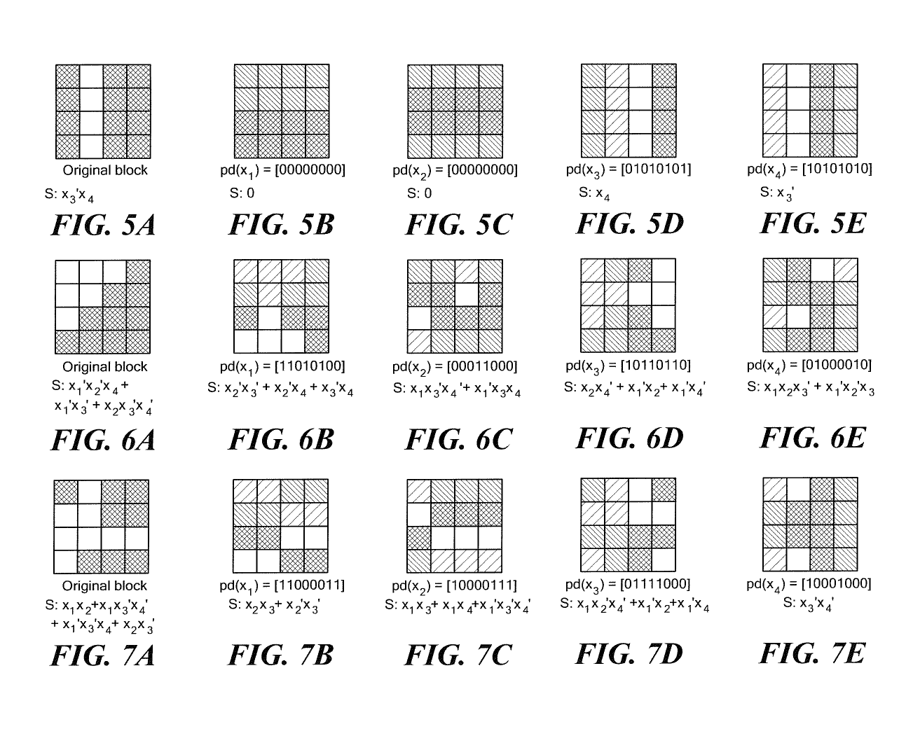

FIGS. 5A-E (vertical edge), 6A-E (diagonal edge), and 7A-E (random block) provide examples to demonstrate the techniques described above and provide a comparison of the binary representation with the sum of primary implicants form (as well as the visual depiction of both). The figures contain several two-dimensional binary blocks (4×4 pixel windows) and their partial derivatives of Boolean functions decompositions.

For an illustrative window/block size of 4×4 pixels (p=q=4), there are 16 total data points. This means the binary input vectors are based on a 4-variable equation with x=(x₁, x₂, x₃, x₄). Therefore each block results in four separate partial derivatives. This is not a one-to-one correspondence, but rather each block and its inverse will result in the same set of partial derivatives. An “inverted block” is where ones are set to zeros, and zeros are set to ones. Below the partial derivatives is a sum of primary implicants (S) representation of each block for comparison.

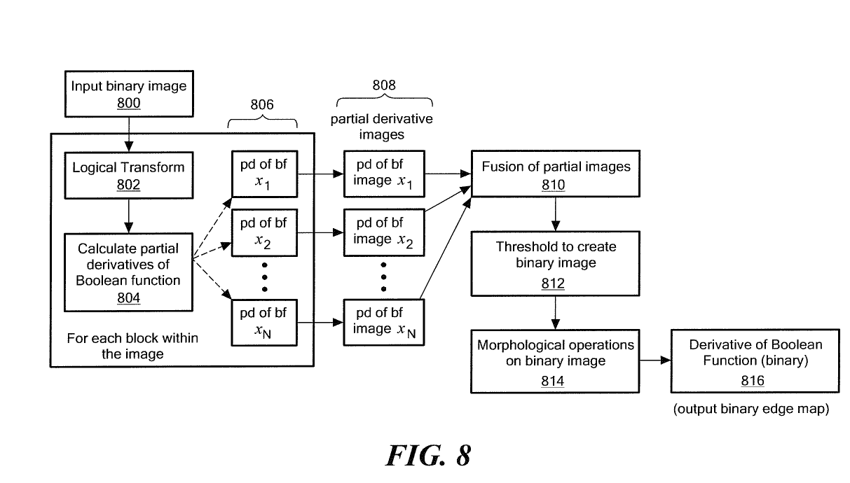

FIG. 8 provides a flow diagram for an exemplary edge detection embodiment for binary image data. A sliding window across the signal generates the individual block inputs for the logical transform 802, such as the Agaian transform. For the sliding window, the image data is divided into windows or blocks of size m×n pixels and each block is transformed into a Boolean treating the pixel values as output of the function. The sum of primary implicants representation that results is used to determine the partial derivatives 804 of the Boolean function as described above. The partial derivatives for each block of the image 806 are then combined back together to form partial derivative images 808, each representing one of the input variables. A combination of these partial images (fusion) 810 is thresholded 812 and a selection of morphological operations is applied (cleaning, thinning, etc) 814. The output from this is the Derivative of Boolean Function (for binary data), and is the binary edge map representation of the original data 816.

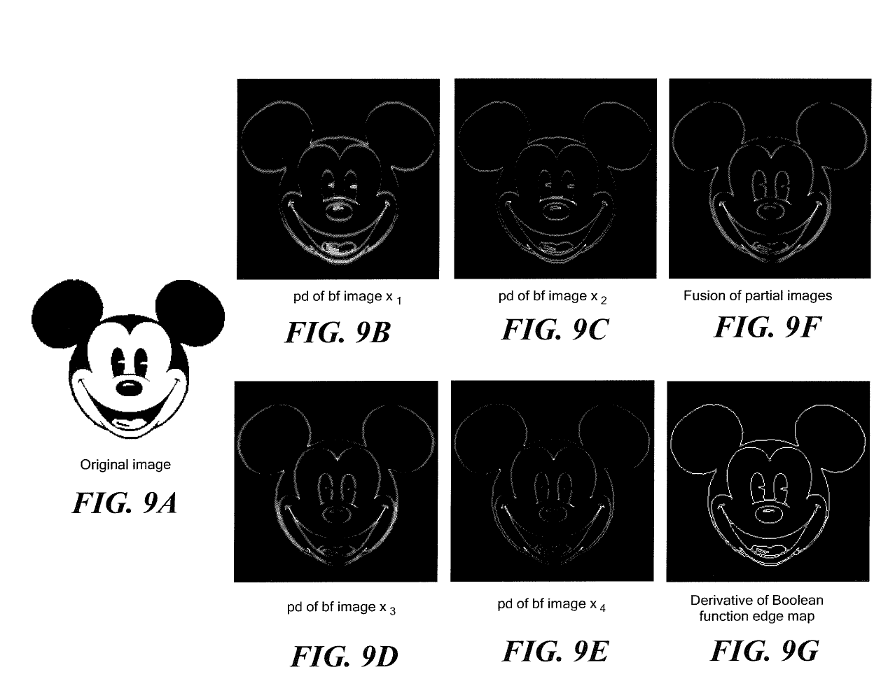

FIGS. 9A-G show exemplary processing of an exemplary image. FIG. 9A shows the input binary image. With a window size of 4×4 (16 data points), there are four resulting partial derivatives of Boolean function (pd of bf) images: x1, x2, x3, and x4, shown in FIGS. 9B-E respectively. The images for each partial derivative are combined together through the fusion process in FIG. 9F. FIG. 9G shows the final image, which can have been passed through some morphological operations. This is the final derivative of the Boolean function edge map (output binary edge map).

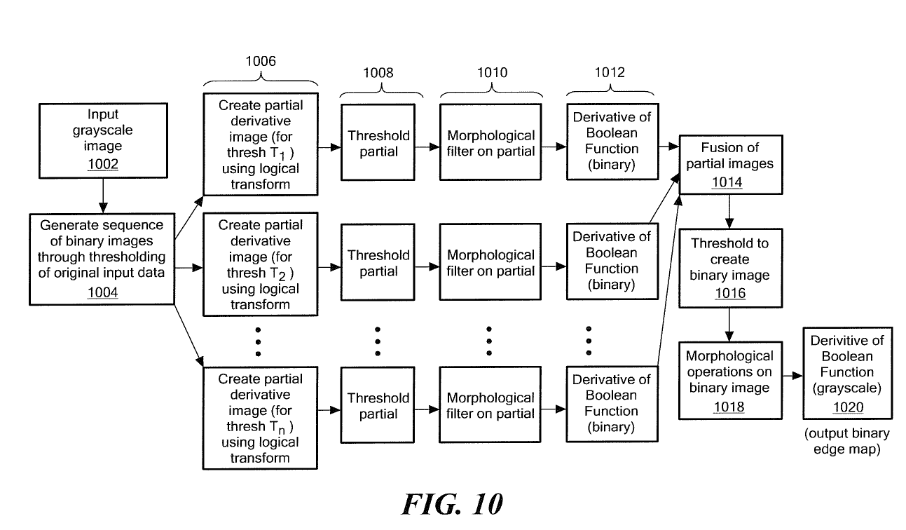

FIG. 10 shows another embodiment for detecting edges within grayscale images. By creating a series of binary datasets 1004 from the original grayscale image 1002 through thresholding 1008, the generation of partial derivative images (using the logical transform) 1006 is similar to that described above for binary images. Once the sequence of partial derivative images has been formed, and processed by a threshold 1008 and the morphological filters 1010, the collection of Derivatives of Boolean Function (binary) 1012 images are again melded together 1014 and the entire group is thresholded 1016 and manipulated one more time using morphological operations 1018. This results in the final Derivative of Boolean Function (grayscale) image 1020, an output binary edge map representation of the original grayscale image.

As noted above, exemplary embodiments of the invention enable processing to handle logical don't care conditions. Known techniques require canonical form, i.e., no minimization, which renders such applications impractical. By using partial derivatives in accordance with the invention, don't care conditions can be calculated.

### EXAMPLE

Image compression can be achieved by using the following approaches:

First method: An image is divided into subimages-blocks of size m×n pixels. This is done because the correlation on the image is generally local so that smaller blocks often result in better compression. Each block may perhaps be preprocessed—such as, by breaking the image into its bit-planes and re-code each pixel value to its Gray-coded value. Blocks in bit-planes of an image are represented as a Boolean function and minimized (for instance using the Logical Transform or other existing techniques). The meaning of these minimizations is to have a compact representation (combination of minterms). The result of these minimizations is used for compression. Specifically, the techniques of “minterm information” and “minterm quantization and thresholding” or coding (for example similar to Hoffman coding) can be applied as methods of discarding perceptually insignificant information from a minimized representation of an image and use data readily available from minimization without the calculation of complicated measures. In a similar manner, image de-noising can be provided.

Second method: An image is divided into subimages-blocks of size p×q pixels. The context classification procedure classifies the image into two main regions:

smooth regions-that may be coded by using an efficient smooth region compression techniques such as run-length, or other method;

non-smooth (the edge information is treated as important area) regions/(blocks) in which simple edge detection based prediction techniques are used for compression.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method, comprising:
transforming a data stream into a Boolean function;
minimizing the Boolean function;
performing r bit-array partial Qth order partial derivatives of the Boolean function, where Q=1 . . . N,
combining the partial derivatives to generate an Nth order Boolean derivative using fusion; and
outputting the Boolean derivative.

2. The method according to claim 1, further including outputting the Boolean derivative to a data processing application.

3. The method according to claim 2, wherein the data processing applications include one or more of image systems, multimedia systems, security systems, video systems, circuit testing and analysis, edge detection, compression, filtering, recognition, noise detection and fault detection, static hazard free circuit design, simplifying gates in circuits, image interpolation, and image resizing.

4. The method according to claim 1, wherein the fusion includes techniques selected based upon a target application.

5. The method according to claim 1, wherein the Boolean function includes a don't care condition.

6. The method according to claim 1, wherein the minimizing includes using one or more of K-Maps, Quinne-McCluskey, Agaian method.

7. The method according to claim 1, wherein the fusion includes one or more of averaging, minimum, maximum, minimum/maximum, maximum/minimum.

8. The method according to claim 1, further including exclusive-ORing a sum of primary implicants.

9. The method according to claim 1, further including performing implicant expansion of the primary implicants.

10. An article, comprising:
a storage medium having stored thereon instructions that when executed by a machine result in the following:
transforming a data stream into a Boolean function;
minimizing the Boolean function;
performing r bit-array partial Qth order partial derivatives of the Boolean function, where Q=1 . . . N, combining the partial derivatives to generate an Nth order Boolean derivative using fusion; and
outputting the Boolean derivative.

11. The article according to claim 10, further including instructions for outputting the Boolean derivative to a data processing application.

12. The article according to claim 10, wherein the fusion includes a technique selected based upon a target application.

13. The article according to claim 10, wherein the Boolean function includes a don't care condition.

14. The article according to claim 10, further including instructions for exclusive-ORing a sum of primary implicants.

15. The article according to claim 1, further including instructions for performing implicant expansion of the primary implicants.

16. A system, comprising:
a processor;
a memory coupled to the processor, the memory including instructions that when executed enable:
transforming a data stream into a Boolean function;
minimizing the Boolean function;
performing r bit-array partial Qth order partial derivatives of the Boolean function, where Q=1 . . . N,
combining the partial derivatives to generate an Nth order Boolean derivative using fusion; and
outputting the Boolean derivative.

17. The system according to claim 16, further including outputting the Boolean derivative to a data processing application.

18. The system according to claim 17, wherein the data processing applications include one or more of image systems, video systems, circuit testing and analysis, edge detection, compression, filtering, recognition, noise detection and fault detection, static hazard free circuit design, simplifying gates in circuits, image interpolation, and image resizing.

19. The system according to claim 17, wherein the Boolean function includes a don't care condition.

20. The system according to claim 17, further including exclusive-ORing a sum of primary implicants.
